(19) United States
(12) Patent Application Publication
(10) Pub. No.: US 2015/0319683 A1
(43) Pub. Date: Nov. 5, 2015

(54) COMMUNICATION SYSTEM, COMMUNICATION DEVICE, AND CONNECTION SELECTION CONTROL METHOD

(71) Applicant: NEC CORPORATION, Tokyo (JP)

(72) Inventor: Hiroaki AMINAKA, Tokyo (JP)

(21) Appl. No.: 14/649,678

(22) PCT Filed: Dec. 6, 2013
(86) PCT No.: PCT/JP2013/007205

§ 371 Date: Jun. 4, 2015

(30) Foreign Application Priority Data
Dec. 6, 2012 (JP) 2012-267721

(51) Int. Cl. H04W 48/18; H04W 36/30; H04W 76/02

(52) U.S. Cl. CPC H04W 48/18; H04W 76/023; H04W 36/30

(57) ABSTRACT

Efficient connection selection is made possible when a mobile station capable of wirelessly connecting directly to a mobile network is also capable of connecting to another mobile network via another mobile station. A first mobile station (10) connectable to a first network (30) and a second mobile station (20) connectable to a second network (40) are included, wherein the first mobile station has a function of connecting to the second network via the second mobile station, and the first mobile station sends an activation request for connection selection control to the second mobile station.

### TECHNICAL FIELD

The present invention relates to a wireless communication system and, more particularly, to communication control techniques for connecting a mobile station to a network.

### BACKGROUND ART

In recent years, mobile stations having wireless LAN (Local Area Network) functions and the like, such as multifunctional mobile telephones (smartphones) and mobile routers, are rapidly becoming prevalent. Such a mobile station is capable of connecting to a mobile network provided by a mobile service provider and the like and is also capable of connecting to another wireless terminal via the wireless LAN and the like. Accordingly, allowing such a mobile station to operate as a bridge or router makes it possible to provide communication services to another wireless terminal via the mobile network.

As an exemplary method of connecting a wireless terminal to a mobile network via the above-described mobile station, PTL 1 discloses a method for establishing a wireless connection of the wireless terminal by using a mobile station that provides the best wireless connection among multiple mobile stations.

### CITATION LIST

### Patent Literature

[PTL 1]
International Publication Number WO03/039178

### SUMMARY OF INVENTION

### Technical Problem

However, with the recent prevalence of smartphones and the like, there arise cases where the wireless terminal described in PTL 1 itself is possibly a mobile station capable of connecting to another mobile network. Such a mobile station (hereinafter, referred to as first mobile station) can use both a first route and a second route, the first route passing through a mobile network to which its user subscribes and a second route passing through a mobile network to which a mobile station operating as a bridge/router as described above (hereinafter, referred to as second mobile station) subscribes. In such an environment, it is preferable to determine, at appropriate timing, which route is more efficient. It is necessary to consider the state of the second route in the determination of a route to use particularly when the first mobile station is set to preferentially select the second route. However, it is the first mobile station that sets up a connection to a network, and the second mobile station cannot learn about the first mobile station's setting up of a connection to the network, which brings about the problem that the second mobile station cannot perform connection selection at appropriate timing.

Accordingly, an object of the present invention is to provide a communication system, a communication device, and a connection selection control method that enables connection selection to be performed at appropriate timing when a mobile station capable of wirelessly connecting directly to a mobile network is also capable of connecting to another mobile network via another mobile station.

### Solution to Problem

A communication system according to the present invention is a communication system including a plurality of networks, comprising a first mobile station connectable to a first network and a second mobile station connectable to a second network, wherein the first mobile station has a function of connecting to the second network via the second mobile station, characterized in that the first mobile station sends an activation request to activate connection selection control to the second mobile station.

A connection selection control method according to the present invention is a connection selection control method in a communication system including a first mobile station connectable to a first network and a second mobile station connectable to a second network, wherein the first mobile station has a function of connecting to the second network via the second mobile station, characterized in that the first mobile station sends an activation request to activate connection selection control to the second mobile station.

A communication device according to the present invention is a communication device in a communication system including first and second networks and a mobile station connectable to the first network, wherein the communication device can connect to the second network and has a function of allowing the mobile station to connect to the second network, characterized by comprising: connection selection control means for selecting a network for the mobile station to connect to, in response to an activation request to activate connection selection control received from the mobile station.

A communication device according to the present invention is a communication device in a communication system including a first mobile station connectable to a first network and a second mobile station connectable to a second network, wherein the first mobile station has a function of connecting to the second network via the second mobile station, the communication device being provided in an upper-level network than a base station in the second network, characterized by comprising: connection selection control means for selecting a network for the first mobile station to connect to, in response to a n request to activate connection selection control received from the first mobile station.

A communication device according to the present invention is a communication device in a communication system including first and second networks and a mobile station connectable to the second network, wherein the communication device can connect to the first network and is capable of wirelessly communicating with the mobile station, characterized by comprising: connection control means that sends a a request to activate connection selection control to the mobile station.

### Advantageous Effects of Invention

According to the present invention, a mobile station notifies a request for connection selection control to another mobile station interposed to connect the mobile station to another network, whereby it is possible to perform connection selection at appropriate timing.

### BRIEF DESCRIPTION OF DRAWINGS

FIG. 1 is a network diagram showing a schematic architecture of a communication system according to an exemplary embodiment of the present invention.

FIG. 2 is a flowchart showing a connection permission/non-permission determination procedure in a communication control method according to the present exemplary embodiment.

FIG. 3 is a block diagram showing a schematic configuration of a first mobile station in the present exemplary embodiment.

FIG. 4 is a block diagram showing a schematic configuration of a second mobile station in the present exemplary embodiment.

FIG. 5 is a block diagram showing a schematic configuration of an upper-level network device in the present exemplary embodiment.

FIG. 6 is a diagram of a communication control sequence in a communication system according to a first example of the present invention.

FIG. 7 is a flowchart showing communication control by the first mobile station in the first example.

FIG. 8 is a flowchart showing communication control by the second mobile station in the first example.

FIG. 9 is a block diagram showing an example of the first mobile station in the first example.

FIG. 10 is a block diagram showing an example of the second mobile station in the first example.

FIG. 11 is a diagram of a communication control sequence in a communication system according to a second example of the present invention.

FIG. 12 is a flowchart showing communication control by the second mobile station in the second example.

FIG. 13 is a flowchart showing communication control by the upper-level network device in the second example.

FIG. 14 is a diagram of a communication control sequence in a communication system according to a third example of the present invention.

FIG. 15 is a flowchart showing communication control by the first mobile station in the third example.

FIG. 16 is a diagram of a communication control sequence in a communication system according to a fourth example of the present invention.

FIG. 17 is a flowchart showing communication control by the first mobile station in the fourth example.

FIG. 18 is a diagram of a communication control sequence in a communication system according to a fifth example of the present invention.

FIG. 19 is a flowchart showing communication control by the first mobile station in the fifth example.

### DESCRIPTION OF EMBODIMENTS

Hereinafter, an exemplary embodiment and examples of the present invention will be described in detail with reference to drawings.

### 1. Exemplary Embodiment

### 1.1) System Architecture

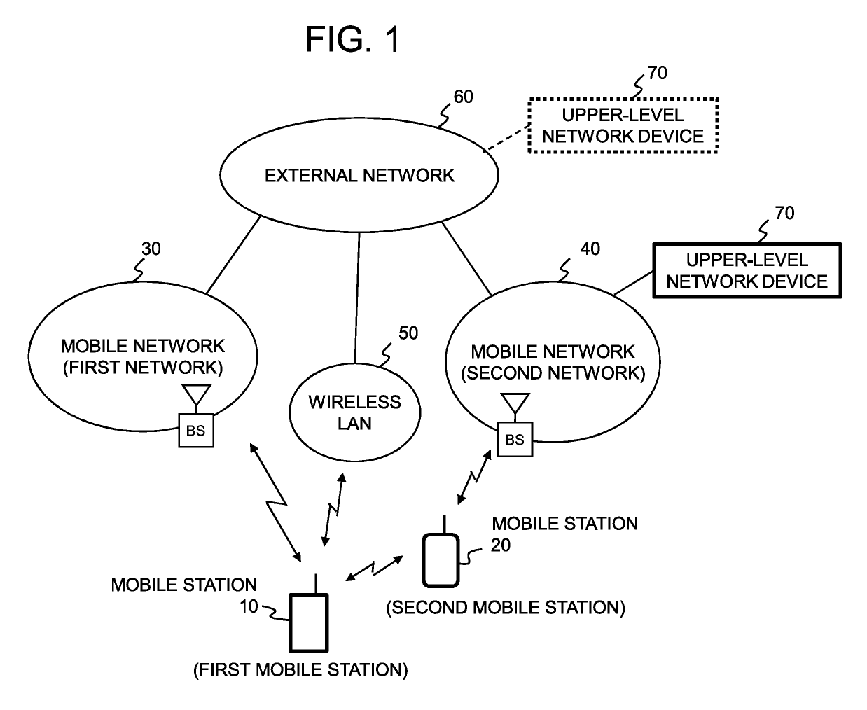

Referring to FIG. 1, a communication system according to an exemplary embodiment of the present invention includes a mobile station 10 that is capable of wirelessly connecting to a mobile network 30 and a wireless LAN 50, and a mobile station 20 that is capable of wirelessly connecting to a mobile network 40. It is assumed that the mobile station 10 can communicate with an external network 60 via each of the mobile network 30 and the wireless LAN 50, and also via the mobile station 20 and the mobile network 40, which will be described later.

The mobile networks 30 and 40 and the wireless LAN 50 are any one of a cellular network, a public wireless LAN, and the like provided by a telecommunication operator (mobile operator or wireless service provider). Typically, the mobile network 40 is a network that cannot be directly accessed by the mobile station 10, which can connect to the mobile network 30 and the wireless LAN 50. For example, the mobile station 10 cannot directly access the mobile network 40 when the mobile networks 30 and 40 are operated by different telecommunication operators. Moreover, if the mobile network operator is a MVNO (Mobile Virtual Network Operator), the mobile station 10 cannot access the mobile network 40 due to the contractual restrictions on service uses.

Further, for another example, in the case where the mobile networks 30 and 40 are of different cellular radio systems operated by the same telecommunication operator or different telecommunication operators, the mobile station 10 cannot access the mobile network 40 due to technical restrictions because, in general, support for different radio access technologies or different NAS protocols is required of the mobile station. Furthermore, the mobile station 10 cannot directly access the mobile network 40 when different authentications are required. For example, that applies to a case where authentications are different because the mobile networks were operated by different operators in the past even if they are being operated by the same telecommunication operator. Alternatively, when different authentications are required in different wireless systems, the mobile station 10 cannot directly access the mobile network 40 because contracts are different. Alternatively, when different frequencies are supported by the mobile stations 10 and 20, the mobile station 10 similarly cannot directly access the mobile network 40.

The external network 60 is a network with which the mobile station 10 or 20 can communicate via the mobile network 30 or 40 or the wireless LAN 50. The external network 50 is, for example, a packet data network, an IP (Internet Protocol) network, the Internet, or another mobile network. An end node communicating with the mobile station 10 may be, for example, a server computer, a personal computer, or a mobile station connected to the external network 60. Moreover, such an end node may be another mobile station connected to the mobile network 30 or 40. Note that communication between the mobile station 10 and the end node is, but is not limited to, for example, internet access, VoIP (Voice over IP) call, voice chat, video chat, video streaming, online game, or the like.

The mobile stations 10 and 20 can wirelessly communicate with each other. For example, a wireless connection between the mobile stations 10 and 20 can be established by using a radio access technology for Wireless LAN based on IEEE 802.11 series, Wireless PAN based on IEEE 802.15 series (e.g., Bluetooth™), or the like. Moreover, it is also possible that the mobile station 10 is a wireless LAN terminal and the mobile network 30 is a public wireless LAN.

The mobile station 20 operates as a bridge/router for transferring data of the mobile station 10. The same radio access technology or difference radio access technologies can be used for a wireless connection between the mobile stations 20 and 10 and a wireless connection between the mobile station 20 and the mobile network 40. The mobile station 20 is, for example, a mobile router, a smartphone with tethering function, or the like and can concurrently establish a connection to the mobile network 40 and a connection to the mobile station 10. That is, the mobile station 20 as a smartphone with tethering function establishes a wireless connection to a base station BS in the mobile network 40 by using a radio access technology for cellular networks, and the mobile station 20 as a mobile router establishes a wireless connection to the mobile station 10 by using a radio access technology for Wireless LAN or Wireless PAN.

As described above, the mobile station 10 is capable of connecting to the mobile network 40 via the mobile station 20. However, according to the present exemplary embodiment, the mobile station 10 sends a request for connection selection control to the mobile station 20, and a connection for the mobile station 10 to use is determined in accordance with such connection selection control, which will be described next. Note that it is sufficient that this connection selection is performed by the mobile station 10 or 20, or at an upper-level network including an upper-level network device 70.

### 1.2) Request for Connection Selection Control

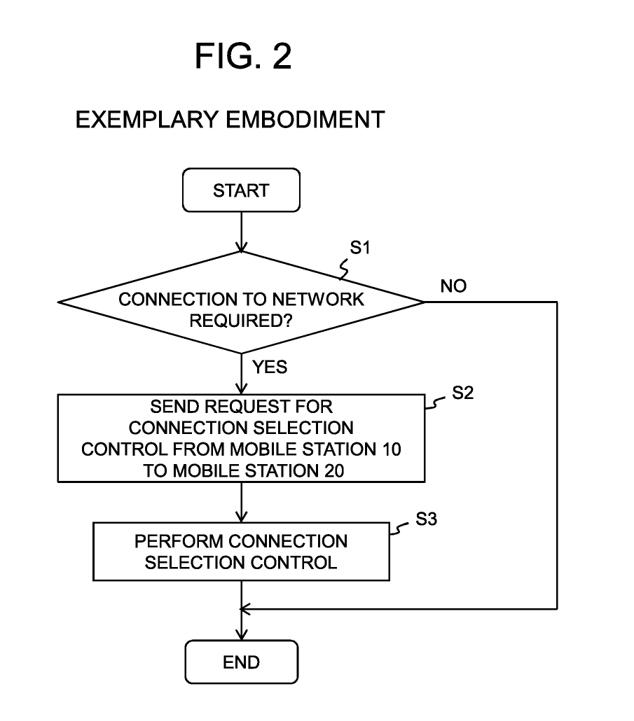

Referring to FIG. 2, when the mobile station 10 needs to connect to a network (Operation S1; YES), the mobile station 10 makes a request to the mobile station 20 for connection selection control (Operation S2). The mobile station 20 can learn about a timing the mobile station 10 starts connecting to a network by receiving the request for connection selection control. Here, a case that requires a connection to a network is, for example, a case where network communication can occur; more particularly, when the display of the mobile station 10 is turned on, when an application involving communication is started up in the mobile station 10, when such an application is operated, when the quality of communication in the mobile network 30 has degraded, when the volume of data for communication is large, or the like.

Responding to the request for connection selection control from the mobile station 10, the mobile station 10 or 20 or the upper-level network device 70 can perform connection selection control (Operation S3). For criteria of connection selection, radio quality, network load, line cost, an operator's policy, a contract plan, and the like can be employed. For example, when the quality of communication in the mobile network 40 is better than in the mobile network 30, connection selection control is performed so that a connection to the mobile network 40 will be selected. Moreover, in a case where the wireless LAN 50 is included, the wireless LAN 50 may be selected if the received quality of a beacon or the like is good.

### 1.3) Effects

As described above, according to the exemplary embodiment of the present invention, the mobile station 10 sends a request for connection selection control to the mobile station 20, and a connection for the mobile station 10 to use is determined in accordance with that connection selection control. Thus, the mobile station 20 or its upper-level network can learn about a timing the mobile station 10 is connecting to a network, which makes it possible to perform connection selection at appropriate timing. Moreover, since connection selection control can be performed in tandem with the start of a service, it is also possible to achieve the prompt and highly reliable provision of services.

### 2. Device Configuration

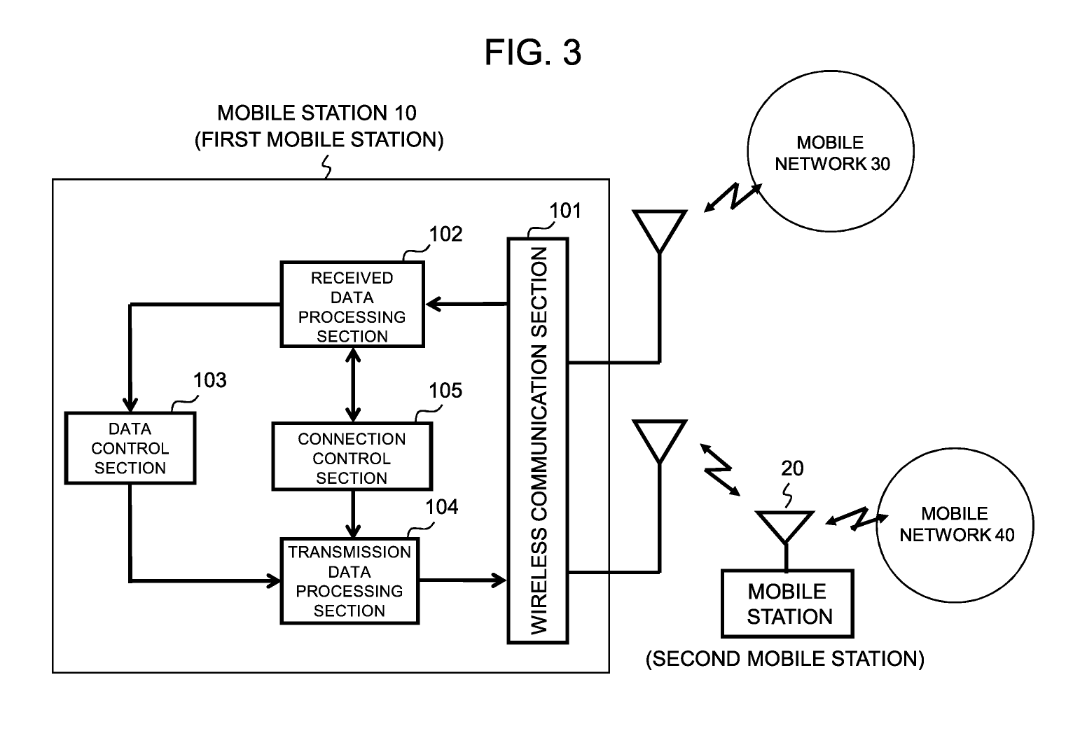

Hereinafter, the schematic configurations of the above-described mobile stations 10 and 20 and the upper-level network device 70 will be described with reference to FIGS. 3 to 5.

### 2.1) Mobile Station 10 (First Mobile Station)

Referring to FIG. 3, the mobile station 10 is a multi-mode terminal such as a smartphone supporting a plurality of radio access schemes. A wireless communication section 101 of the mobile station 10 wirelessly connects to a base station BS in the mobile network 30 by using a predetermined radio access scheme (e.g., URAN (UMTS Terrestrial Radio Access Network), E-UTRAN (Evolved UTRAN), GERAN (GSM EDGE Radio Access Network), WiMAX (Worldwide Interoperability for Microwave Access), or the like), and thus can communicate with an end node via the mobile network 30. Moreover, it may also communicate with an end node via the wireless LAN 50 by using a wireless LAN scheme. Further, the wireless communication section 101 wirelessly connects to the mobile station 20 by using a radio access scheme for Wireless LAN, Wireless PAN, or the like as described above, and thus can communicate with an end node via the mobile station 20 and the mobile network 40.

The mobile station 10 further includes a received data processing section 102, a data control section 103, a transmission data processing section 104, and a connection control section 105. The received data processing section 102 and the transmission data processing section 104 process data received from and to be transmitted to the mobile network 30, the wireless LAN 50, or the mobile station 20 under control of the connection control section 105, while the data control section 103 performs control or the like over the transmission data processing section 104 in response to received data.

The connection control section 105 may store the quality of communication in the mobile network 30 as connection information in a memory (not shown) and control the transmission data processing section 104 to send this connection information in response to a request from the mobile station 20. Moreover, the connection control section 105 can also control the transmission data processing section 104 to send a request for connection selection control to the mobile station 20 based on the quality of a connection in the mobile network 30 and store a result of selection received from the mobile station 20.

Further, the connection control section 105 can also perform connection selection control based on the connection information of its own station and connection information notified from the mobile station 20, which will be described later.

### 2.2) Mobile Station 20 (Second Mobile Station)

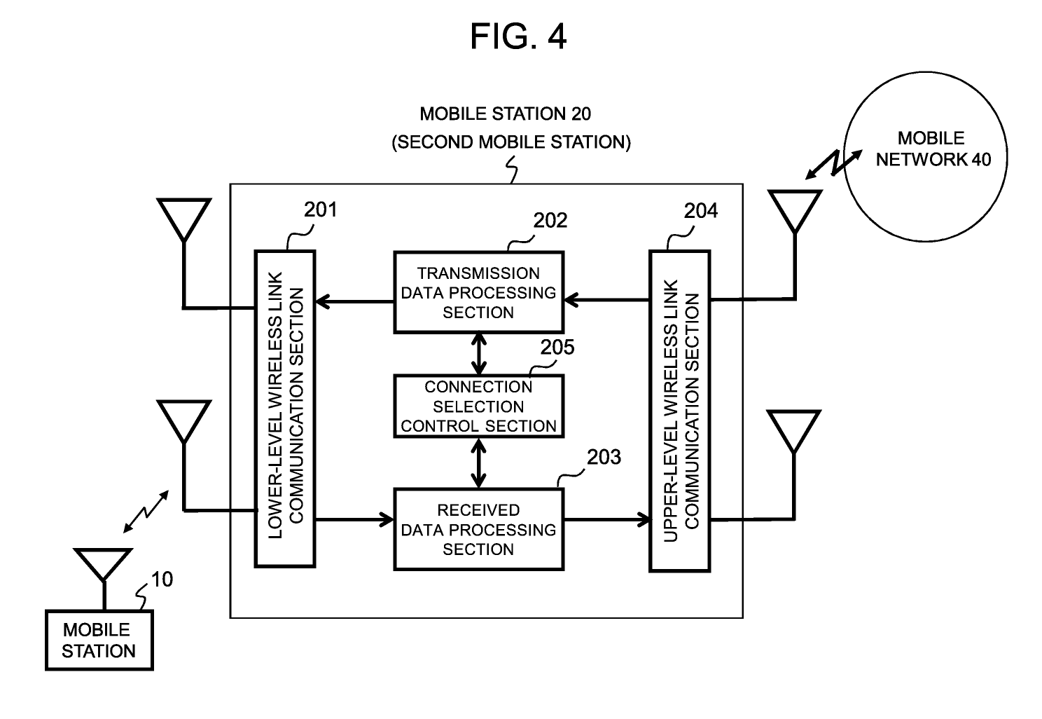

Referring to FIG. 4, the mobile station 20 is, for example, a smartphone having tethering function or a mobile router such as a WiFi router as described already, and performs control for transferring data transmitted and received between the mobile station 10 and the mobile network 40. A lower-order wireless link communication section 201 wirelessly connects to the mobile station 10 by using a radio access scheme for Wireless LAN, Wireless PAN, or the like as described above, transmits transmission data from a transmission data processing section 202 to the mobile station 10, and also outputs data received from the mobile station 10 to a received data processing section 203. An upper-level wireless link communication section 204 wirelessly connects to a base station in the mobile network 40 by using the above-described same radio access scheme that is used for the mobile station 10 or a different radio access scheme, and thus can communicate with the mobile network 40.

A connection selection control section 205 can perform connection selection control in response to a request from the mobile station 10, based on connection information on the mobile network 30 received from the mobile station 10 and connection information on the mobile network 40. Alternatively, in a case where connection selection control is performed at the upper-level network, the connection selection control section 205 can transfer the connection information to the upper-level network device 70 via the mobile network 40 and keep a result of connection selection when receiving it, and can also transfer it to the mobile station 10.

### 2.3) Upper-Level Network Device 70 (Upper-Level Network)

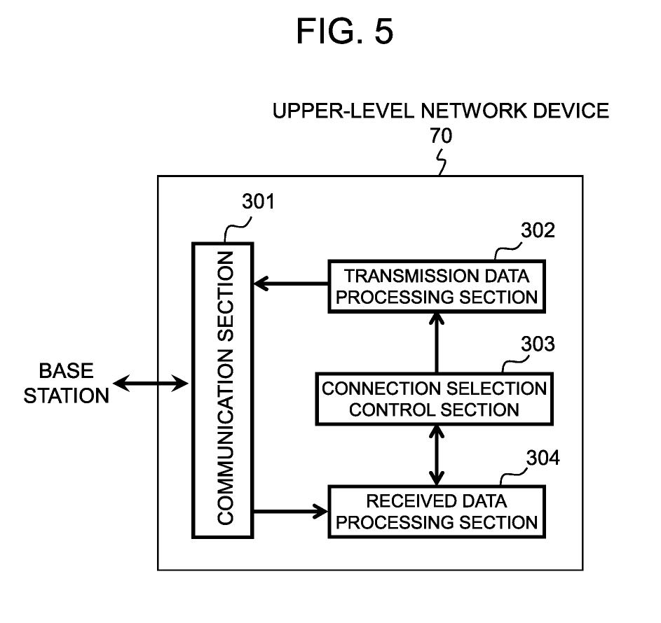

Referring to FIG. 5, the upper-level network device 70 includes a communication section 301 for communicating with base stations in the mobile network 40, a transmission data processing section 302, and a received data processing section 304. Further, when connection selection control is performed, a connection selection control section 303 can perform connection selection control for the mobile station 10 based on connection information received from a lower-level network and return a result thereof. Note that the upper-level network device 70 is an upper-level server or the like that is provided in the mobile network 40 or the external network 60 and is capable of obtaining connection information.

Hereinafter, a detailed description will be given of a connection selection control method for a communication system to which the above-described exemplary embodiment of the present invention is applied, with reference to drawings.

### 3. First Example

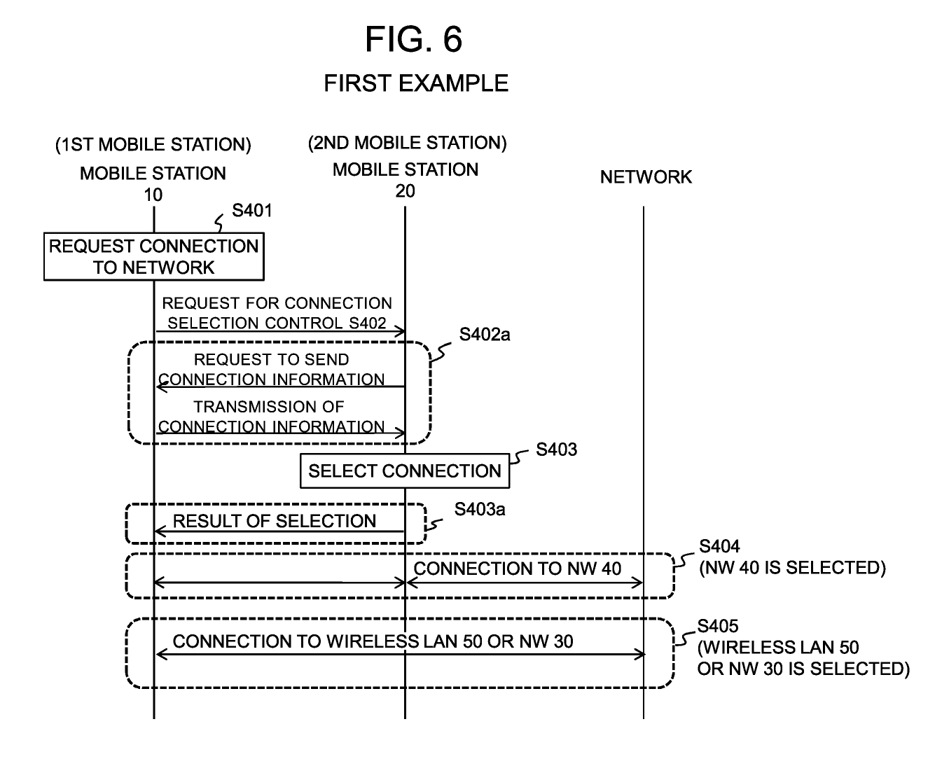

According to a first example of the present invention, the mobile station 20 performs connection selection control in response to a request for connection selection control from the mobile station 10. Hereinafter, system operations according to the first example and specific examples of the mobile stations 10 and 20 will be described with reference to FIGS. 6 to 10.

### 3.1) System Operations

Referring to FIG. 6, when the mobile station 10 determines that it is necessary to connect to a network (Operation S401), the mobile station 10 sends a request for connection selection control to the mobile station 20 (Operation S402). The request for connection selection control may include information required for connection selection, such as, for example, information on the radio quality of the mobile network 30 (connection information), the type of an application to be used, a data size, or a required throughput. Alternatively, it is also possible that the mobile station 20 having received the request for connection selection control requests the mobile station 10 to send connection information and the mobile station 10, in response to it, sends the connection information of its own station to the mobile station 20 (Operation S402a).

The connection information on the mobile networks 30 and 40 can also be collected by the mobile station 20 measuring them. Alternatively, the respective connection information may be measured by the mobile stations 10 and 20 individually, mutually notified, and thereby shared. Alternatively, it is also possible that the mobile station 20 measures connection information on part of the frequency band of the mobile network 30 and the mobile station 10 measures connection information on the rest of the frequency band. Note that in a case where the mobile stations 10 and 20 collect connection information in concert, the mobile station 10 may send the connection information along with the request for connection selection control, or the mobile station 20 may send the connection information along with the request for connection information.

The mobile station 20 having received the request for connection selection control, the connection information and the like as described above from the mobile station 10, performs connection selection based on the connection information and the like (Operation S403). Note that a result of the selection may be sent to the mobile station 10 (Operation S403a). If the mobile station 10 is set to preferentially select a wireless LAN connection, the mobile station 20 can have the mobile station 10 automatically select a connection by turning on/off its wireless LAN function. For example, when the mobile station 20 turns on the wireless LAN function, the mobile station 10 preferentially select the mobile network 40 (Operation S404). When the mobile station 20 turns off the wireless LAN function, the mobile station 10 selects the wireless LAN 50 or the mobile network 30 (Operation 405). In a case where a result of the selection is sent to the mobile station 10, the mobile station 10 selects the mobile network 40, the mobile network 30, or the wireless LAN 50 in accordance with that result of the selection (Operation S404 or S405).

In the above-described system sequence, the mobile stations 10 and 20 individually perform control, which will be described next.

### 3.2) Control Operations of Mobile Stations

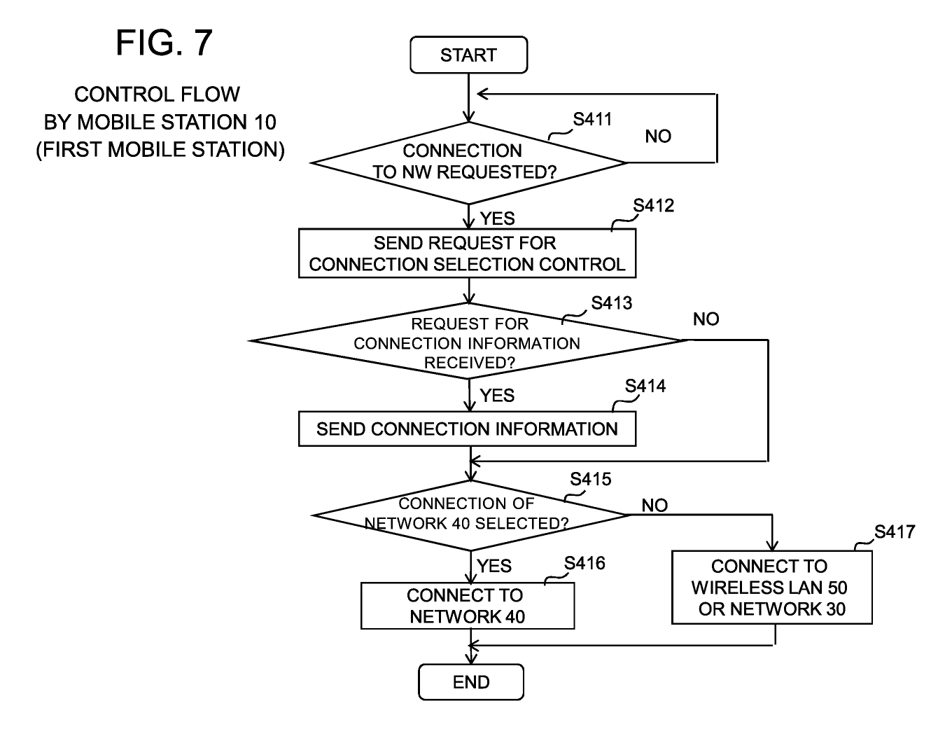

Referring to FIG. 7, when the mobile station 10 starts requesting a connection to a network (Operation S411; YES), the connection control section 105 controls the transmission data processing section 104, so that a request for connection selection control is sent to the mobile station 20 from the wireless communication section 101 (Operation S412). Subsequently, if a request to send connection information is received from the mobile station 20 (Operation S413; YES), the data control section 103 reads measured connection information and sends it to the mobile station 20 via the transmission data processing section 104 and the wireless communication section 101 (Operation S414). Operation S414 is not performed when a request to send connection information is not received (Operation S413; NO). Subsequently, if the wireless LAN function of the mobile station 20 is turned on (or a result that a connection of the mobile network 40 is selected is received) as described above, a connection in the network 40 is selected (Operation S415; YES), and the connection control section 105 connects to the mobile network 40 through a wireless LAN connection between the wireless communication section 101 and the mobile station 20 (Operation S416). When the wireless LAN function of the mobile station 20 is turned off (or a result that a connection in the mobile network 30 is selected is received), a connection in the network 30 is selected (Operation S415; NO), and the connection control section 105 has the wireless communication section 101 connect to a base station in the wireless LAN 50 or the mobile network 30 (Operation S417).

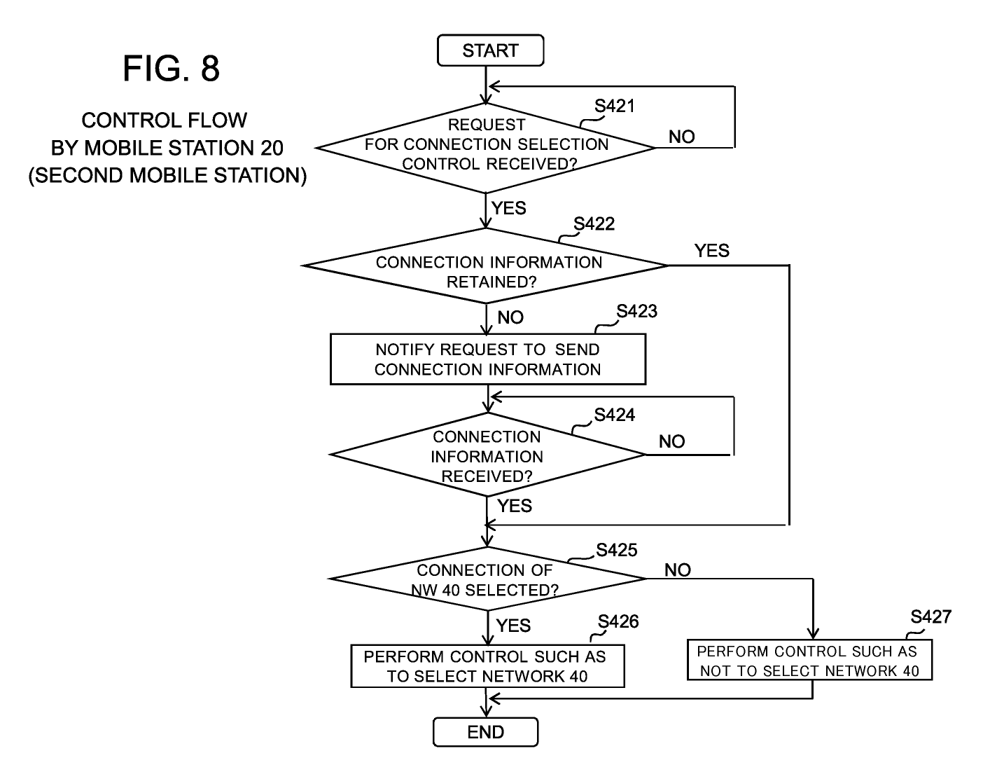

Referring to FIG. 8, when the mobile station 20 has received a request for connection selection control from the mobile station 10 (Operation S 421; YES), the connection selection control section 205 determines whether or not the connection information of this mobile station 10 is retained (Operation S422). If it is not retained (Operation S422; NO), a request to send connection information is sent to the mobile station 10 from the lower-order wireless link communication section 201 (Operation S423). When the connection information is received from the mobile station 10 in response to this request to send connection information (Operation S424; YES), or when such connection information is already retained (Operation S 422; YES), the connection selection control section 205 performs connection selection control based on the connection information of its own station and the mobile station 10 (Operation S 425). When selecting a connection in the mobile network 40 (Operation S425; YES), the connection selection control section 205 turns on the wireless LAN function or sends a result that the network 40 is selected to the mobile station 10 from the lower-order wireless link communication section 201 (Operation S426). When not selecting the mobile network 40 (Operation S425; NO), the connection selection control section 205 turns off the wireless LAN function or sends a result that the network 40 is not selected to the mobile station 10 from the lower-order wireless link communication section 201 (Operation S427).

### 3.3) Examples of Configuration of Mobile Stations

The above-described respective control operations of the mobile stations 10 and 20 can also be implemented by executing programs on a processor (computer) installed on each mobile station. Hereinafter, an example of implementation by using software will be described briefly.

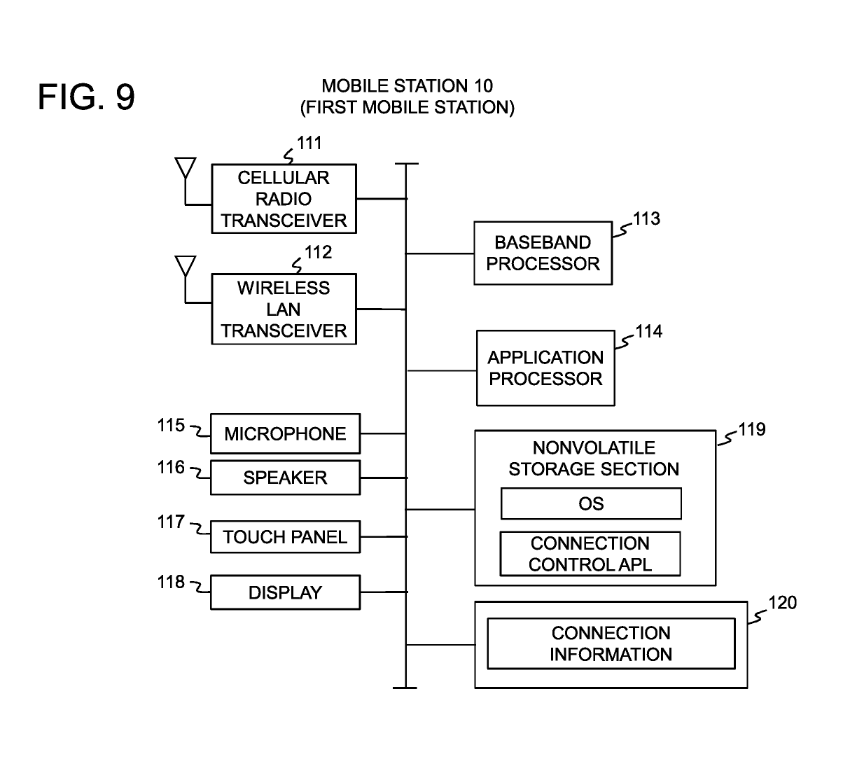

Referring to FIG. 9, the mobile station 10 includes, for the wireless communication section 101 in FIG. 3, a cellular radio transceiver 111, a wireless LAN transceiver 112, and a baseband processor 113. Moreover, as specific examples of input and output devices, a microphone 115, a speaker 116, a touch panel 117, and a display 118 are included. An application processor 114 implements various functions of the mobile station 10 by executing system software programs (OS (Operating System)) and programs of a connection control application and various applications (e.g., web browser and mailer) read from a nonvolatile storage section 119.

The nonvolatile storage section 119 is, for example, a flash memory, a hard disk drive, or the like. The application processor 114 executes the connection control application, whereby the above-described functions of the connection control section 105 are implemented. Moreover, connection information measured by its own station is stored beforehand in the nonvolatile storage section 119 or another nonvolatile storage section 120 and sent to the mobile station 20 through the above-described connection control process. Note that the connection control section 105 of the mobile station 10 may also be implemented by a semiconductor device including an ASIC or ASICs (Application Specific Integrated Circuit).

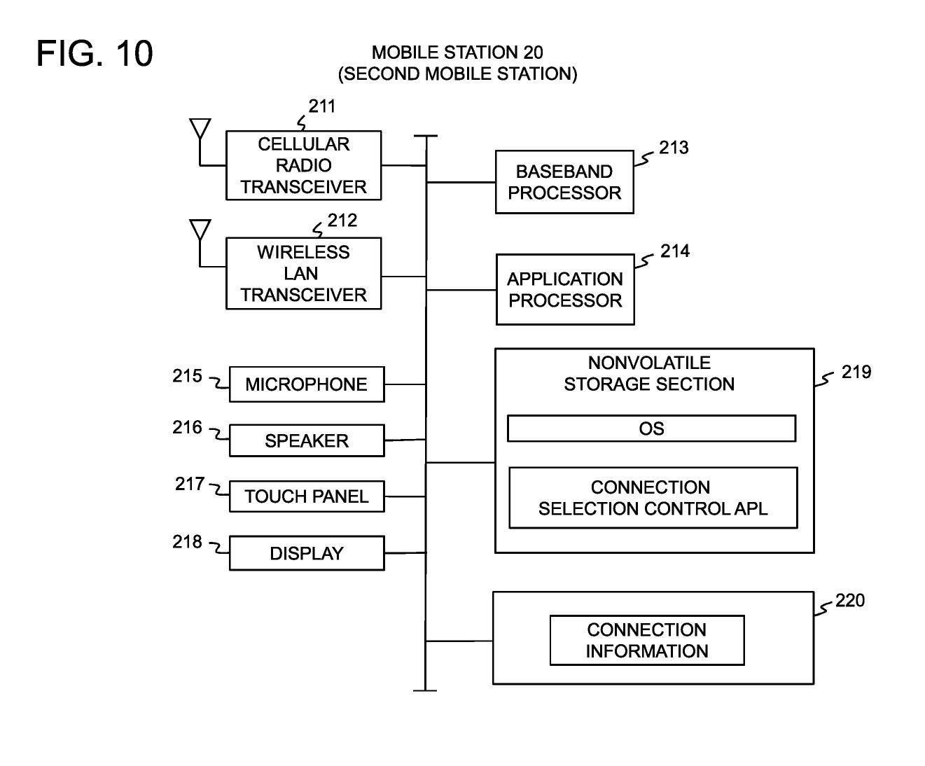

Referring to FIG. 10, the mobile station 20 includes, for the upper-level wireless link communication section 204 and the lower-order wireless link communication section 201 in FIG. 4, a cellular radio transceiver 211, a wireless LAN transceiver 212, and a baseband processor 213. Moreover, as specific examples of input and output devices, a microphone 215, a speaker 216, a touch panel 217, and a display 218 are included. An application processor 214 implements various functions, including the tethering function, of the mobile station 20 by executing system software programs (OS (Operating System)) and programs of a connection selection control application, a connection permission/non-permission determination application, and various applications (e.g., web browser and mailer) read from a nonvolatile storage section 219.

The nonvolatile storage section 219 is, for example, a flash memory, a hard disk drive, or the like. The application processor 214 executes the connection selection control application, whereby the above-described functions of the connection selection control section 205 are implemented. Moreover, connection information measured by its own station and connection information received from the mobile station 10 are stored in the nonvolatile storage section 219 or another nonvolatile storage section 220 and used in the above-described connection selection control process. Note that the connection control section 205 of the mobile station 20 may also be implemented by a semiconductor device including an ASIC or ASICs (Application Specific Integrated Circuit).

The above-described various programs for the mobile stations 10 and 20 are stored by using various types of non-transitory computer readable media, and thus can be provided to the computers. The non-transitory computer readable media include various types of tangible storage media. Examples of non-transitory computer readable media include magnetic storage media (e.g., flexible disk, magnetic tape, and hard disk drive), magneto-optical storage media (e.g., magneto-optical disk), CD-ROM (Read Only Memory), CD-R, CD-R/W, and semiconductor memories (e.g., mask ROM, PROM (Programmable ROM), EPROM (Erasable PROM), flash ROM, and RAM (Random Access Memory)). Moreover, the programs may also be provided to the computers by using various types of transitory computer readable media. Examples of transitory computer readable media include electric signals, optical signals, and electromagnetic waves. The transitory computer readable media can provide the programs to the computers through a wired communication line such as electric wire or optical fiber, or through a wireless communication connection.

### 4. Second Example

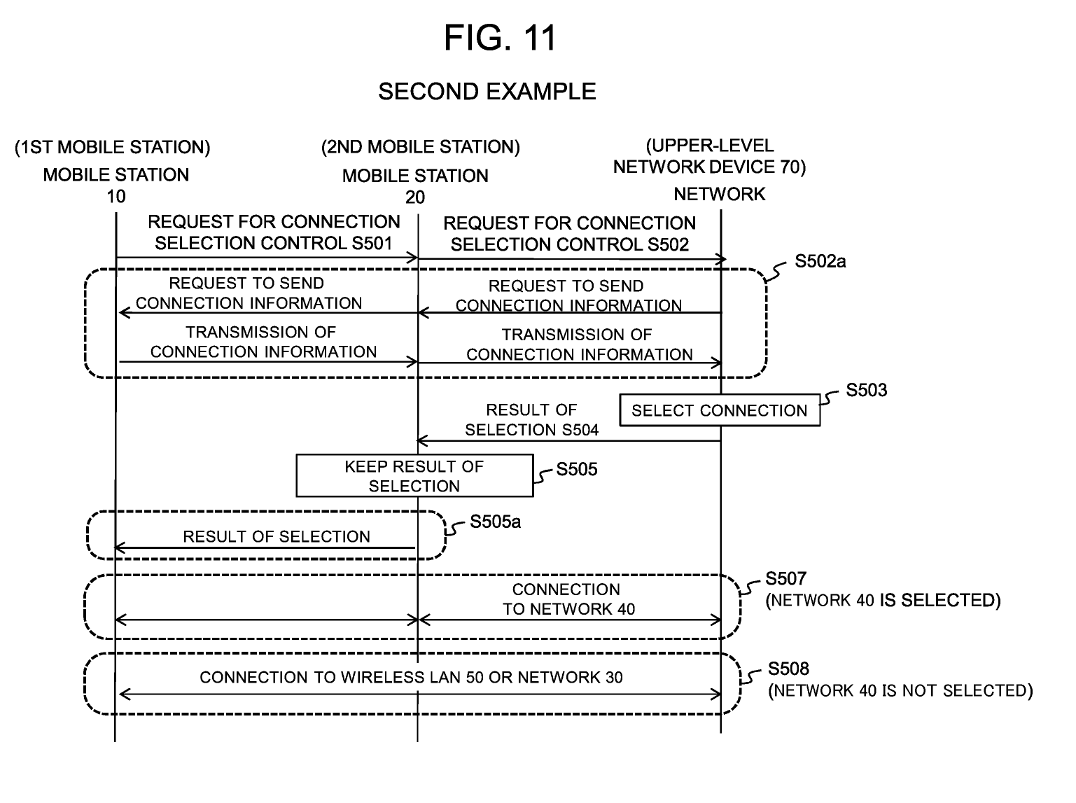

According to a second example of the present invention, the upper-level network device 70 performs connection selection control, in response to a request for connection selection control from the mobile station 10. Hereinafter, system operations and operations of the mobile station 20 and the upper-level network device 70 according to the second example will be described with reference to FIGS. 11 to 13.

### 4.1) System Operations

Referring to FIG. 11, when a request for connection selection control is received from the mobile station 10 (Operation S501), the connection selection control section 205 of the mobile station 20 transfers the request for connection selection control to the upper-level network device 70 via the mobile network 40 (Operation S502). In this event, if connection information is also notified together from the mobile station 10, the mobile station 20 may also transfer it along with the connection information of its own station to the upper-level network device 70. Alternatively, it is also possible that the upper-level network device 70 having received the request for connection selection control makes a request to the mobile stations 10 and 20 for connection information and, in response to that, the mobile stations 10 and 20 send the respective connection information (Operation S502a).

The upper-level network device 70 having received the request for connection selection control and the connection information from the mobile station 20 performs connection selection control based on the connection information (Operation S503) and sends a result of the selection to the mobile station 20 (Operation S504). The mobile station 20 keeps the received result of the selection (Operation S505) and may further transfer the result of the selection to the mobile station 10 (Operation S505a).

When a connection in the mobile network 40 is selected for the mobile station 10, the mobile station 20 transfers data from the mobile station 10 to the mobile network 40 and transfers data destined to the mobile station 10 from the mobile network 40 to the mobile station 10 (Operation S506), wherein the identification of data is performed based on the MAC address of the mobile station 10. When a connection in the mobile network 40 is not selected, the mobile station 10 switches connections to select the wireless LAN 50 or the mobile network 30 and thus can transmit and receive data (Operation S507).

In the above-described sequence, the mobile station 20 and the upper-level network device 70 perform control as described next.

### 4.2) Control Operations

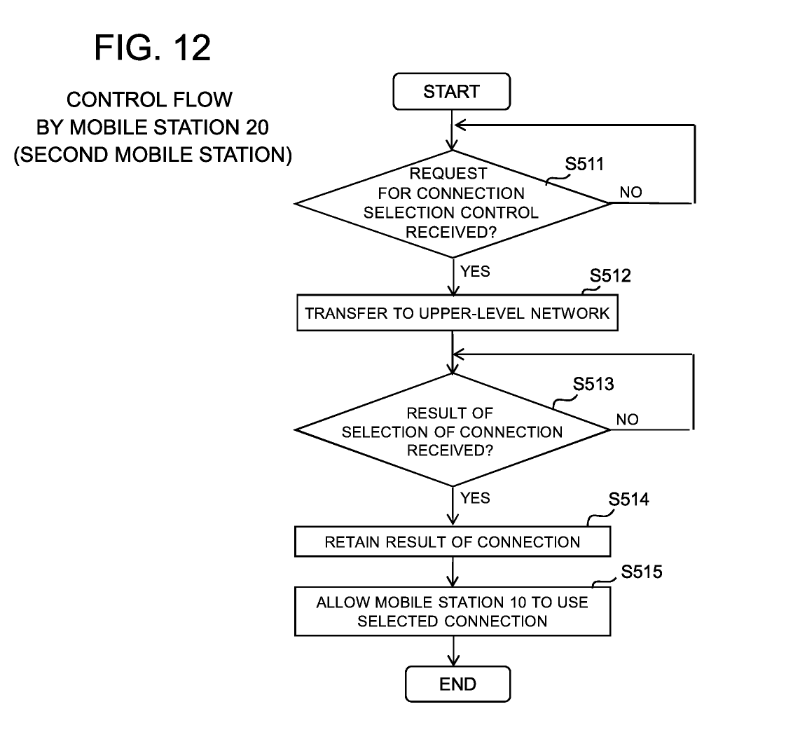

Referring to FIG. 12, when the mobile station 20 has received a request for connection selection control from the mobile station 10 (Operation S511; YES), the connection selection control section 205 transfers the request for connection selection control to the upper-level network (Operation S512) and waits for a result of selection from the upper-level network (Operation S513; NO). When receiving a result of selection from the upper-level network (Operation S513; YES), the connection selection control section 205 keeps this result of selection (Operation S514) and allows the mobile station 10 to use the selected connection (Operation 515). That is, as described above, when a connection in the mobile network 40 is selected, the connection selection control section 205 turns on the wireless LAN function or sends a result that the mobile network 40 is selected to the mobile station 10 from the lower-level wireless link communication section 201. When the mobile network 40 is not selected, the connection selection control section 205 turns off the wireless LAN function or sends a result that the network 40 is not selected to the mobile station 10 from the lower-level wireless link communication section 201.

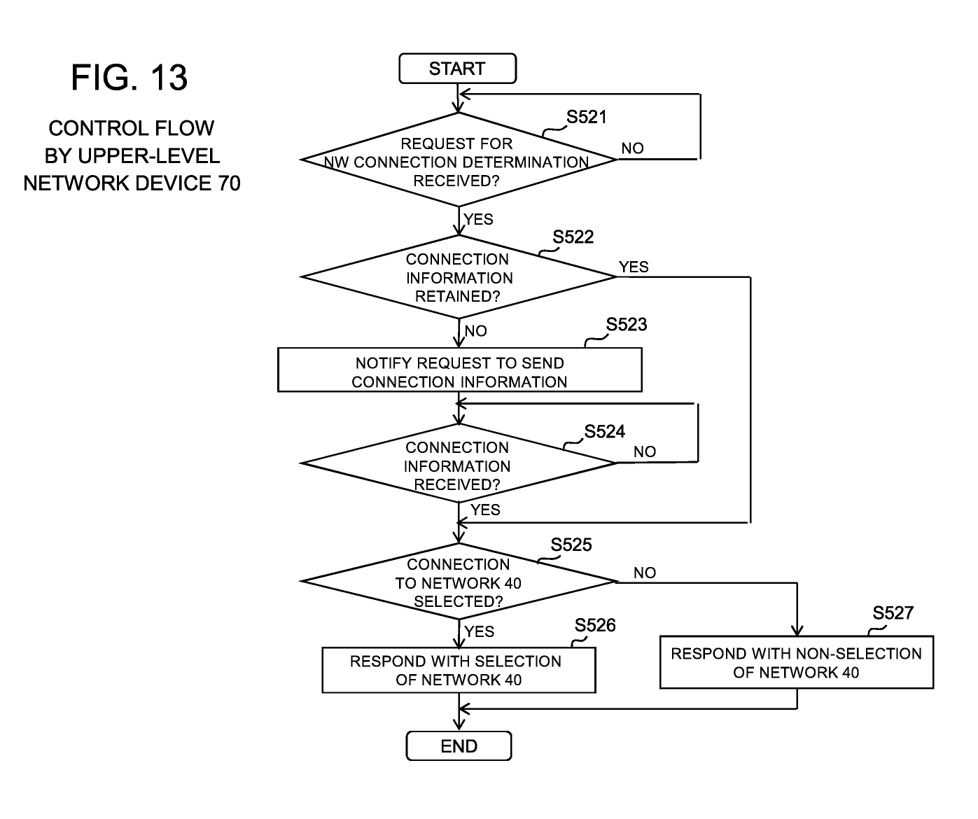

Referring to FIG. 13, when the upper-level network device 70 has received the request for connection selection control from the mobile station 20 (Operation S521; YES), the connection selection control section 303 determines whether or not the connection information of the mobile stations 10 and 20 is retained (Operation S522) and, when it is not retained (Operation S522; NO), sends a request to send connection information to the mobile stations 10 and 20 from the communication section 301 (Operation S523). When the connection information is received in response to this request to send connection information (Operation S524; YES), or when the connection information is already retained (Operation S522; YES), the connection selection control section 303 performs connection selection control based on the connection information (Operation S525). When selecting a connection to the mobile network 40 (Operation S525; YES), the connection selection control section 303 sends a result of that selection to the mobile station 20 from the communication section 301 (Operation S526). When not selecting a connection to the mobile network 40 (Operation S525; NO), the connection selection control section 303 sends a result of that selection to the mobile station 20 from the communication section 301 (Operation S527).

Note that the responses with a result of the selection in Operations S526 and S527 may also be performed by indicating to turn on/off the wireless LAN function of the mobile station 20. For example, if the connection control section 105 of the mobile station 10 is set to always prioritize a wireless LAN connection, the mobile station 10 is allowed to connect to the mobile network 40 via the mobile station 20 by turning on the wireless LAN function of the mobile station 20. The mobile station 10 can be made to automatically connect to the wireless LAN 50 or the mobile network 30 by turning off the wireless LAN function of the mobile station 20.

As described above, according to the second example of the present invention, the upper-level network device 70 performs connection selection in response to a request for connection selection control from the mobile station 10, whereby it becomes unnecessary to change the configurations and operations of the mobile stations 10 and 20.

### 5. Third Example

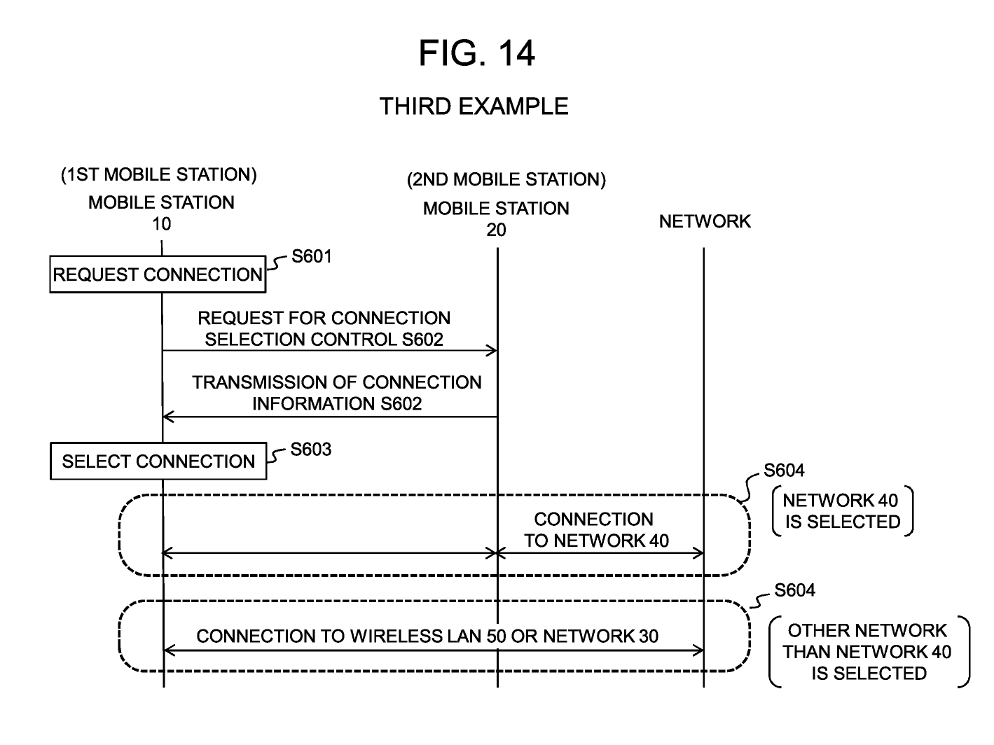

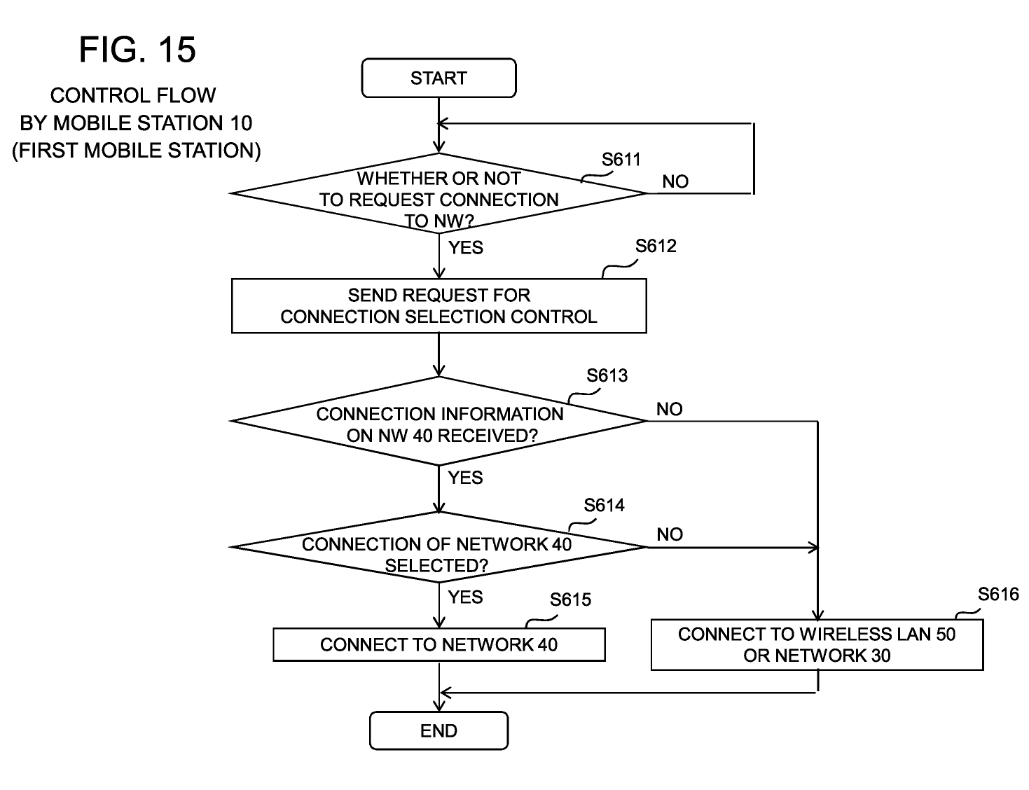

According to a third example of the present invention, the mobile station 10 performs connection selection control itself in response to its own request for a connection to a network. Hereinafter, system operations and operations of the mobile station 10 according to the third example will be described with reference to FIGS. 14 and 15.

Referring to FIG. 14, when the mobile station 10 requests a connection to a network (Operation S601), the mobile station 10 sends a request for connection selection control to the mobile station 20 (Operation S602), and in response to this, the mobile station 20 sends back connection information the mobile station 20 itself has measured (Operation S602). The mobile station 10 performs connection selection control using the connection information of the mobile station 20 and connection information the mobile station 10 itself has measured (Operation S603). If a connection in the mobile network 40 is selected, a connection to the mobile network 40 is established via the mobile station 20 (Operation S604). If a connection in the mobile network 40 is not selected, the connection control section 105 connects to the wireless LAN 50 or the mobile network 30 (Operation S605).

Referring to FIG. 15, when the mobile station 10 attempts to request a connection to a network (Operation S611), the connection control section 105 sends a request for connection selection control to the mobile station 20 (Operation S612). When receiving connection information on the mobile network 40 from the mobile station 20 in response to that (Operation S613; YES), the connection control section 105 performs connection selection control using the connection information of the mobile station 20 and connection information the mobile station 10 itself has measured (Operation S614). If a connection in the mobile network 40 is selected, a connection is made to the mobile network 40 via the mobile station 20 (Operation S615). If no connection information is received from the mobile station 20 (Operation S613; NO), or if a connection in the mobile network 40 is not selected (Operation S614; NO), the connection control section 105 connects to the wireless LAN 50 or the mobile network 30 (Operation S616).

As described above, according to the third example of the present invention, the mobile station 10 itself performs control for selecting a connection in the mobile network 40 in response to its own request for a connection to a network. Consequently, signal traffic is reduced.

### 6. Fourth Example

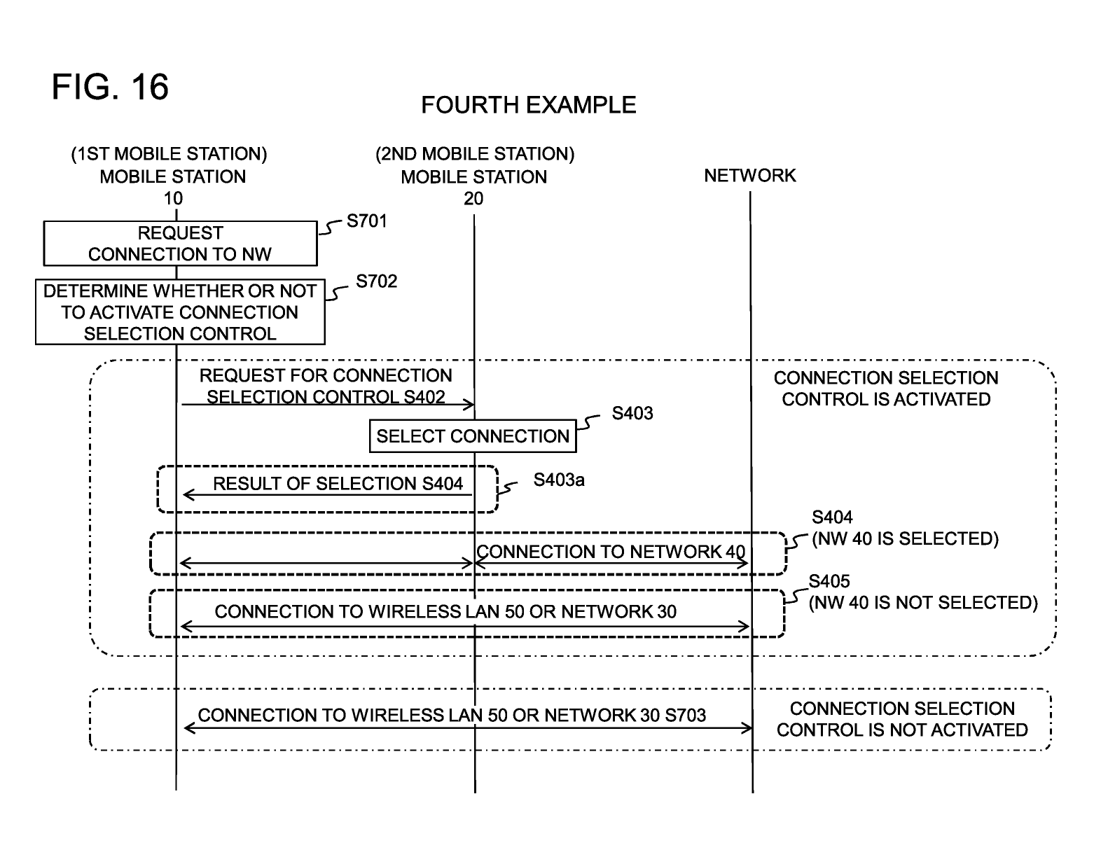

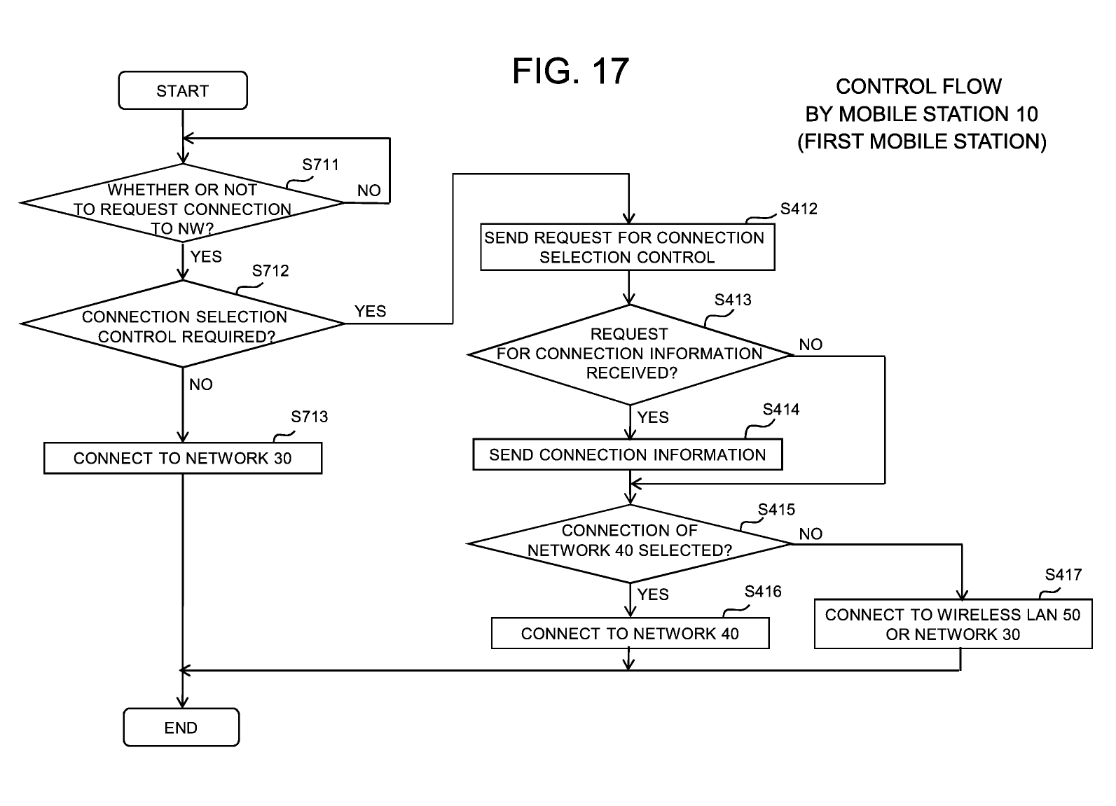

According to a fourth example of the present invention, the mobile station 10 determines whether or not to activate connection selection control, and when the determination is to activate it, connection selection control is performed by the mobile station 20 or at the upper-level network. Hereinafter, system operations and operations of the mobile station 10 according to the fourth example will be described with reference to FIGS. 16 and 17.

### 6.1) System Operations

Referring to FIG. 16, when the mobile station 10 requests a connection to a network (Operation S701), the mobile station 10 determines whether or not to activate connection selection control (Operation S702). In case of starting up connection selection control, the mobile station 10 sends a request for starting up connection selection control to the mobile station 20 (Operation S402), and thereafter Operations S402 to S405 are performed as in the first example shown in FIG. 6. Note that connection selection control may be performed at the upper-level network as in the second example shown in FIG. 11. In case of not starting up connection selection control, the mobile station 10 connects to the mobile network 30 (Operation S703).

Criteria for determination as to whether or not to activate connection selection control are as follows:

### a) Service Type

Connection selection control is started up in case of a non-real time application (such as Web or FTP), but connection selection control is not started up in case of a real time application;

### b) Radio Quality

Connection selection control is started up when the radio quality in the mobile network 30 degrades to a predetermined value or below;

### c) Data Size

Connection selection control is started up when the size of data the mobile station 10 transmits or receives is larger than a predetermined value; and

### d) Throughput

The maximum value, minimum value, or mean value of throughput required for a service is estimated, and connection selection control is started up when such an estimated value is not smaller than a predetermined value.

In the above-described system sequence, since control by the mobile station 20 is similar to that in the first example shown in FIG. 8, control by the mobile station 10 will be described hereinafter.

### 6.2) Control Operations of Mobile Station

Referring to FIG. 17, when the mobile station 10 starts requesting a connection to a network (Operation S711; YES), the connection control section 105 determines whether or not to activate connection selection control (Operation S712). In case of not starting up connection selection control (Operation S712; NO), the connection control section 105 has the wireless communication section 101 connect to a base station in the mobile network 30 (Operation S713). In case of starting up connection selection control (Operation S712; YES), the connection control section 105 sends a request for connection selection control to the mobile station 20 from the wireless communication section 101 (Operation S412). Thereafter, operations are similar to those in the first example shown in FIG. 7 (S412 to S417), and therefore a description thereof will be omitted.

As described above, according to the fourth example, the mobile station 10 determines whether or not to activate connection selection control based on the service type, radio quality, or the like, whereby prompt determination can be made for appropriate connection selection, making it possible to lighten load on the mobile station 20 and to reduce delays in connection.

### 7. Fifth Example

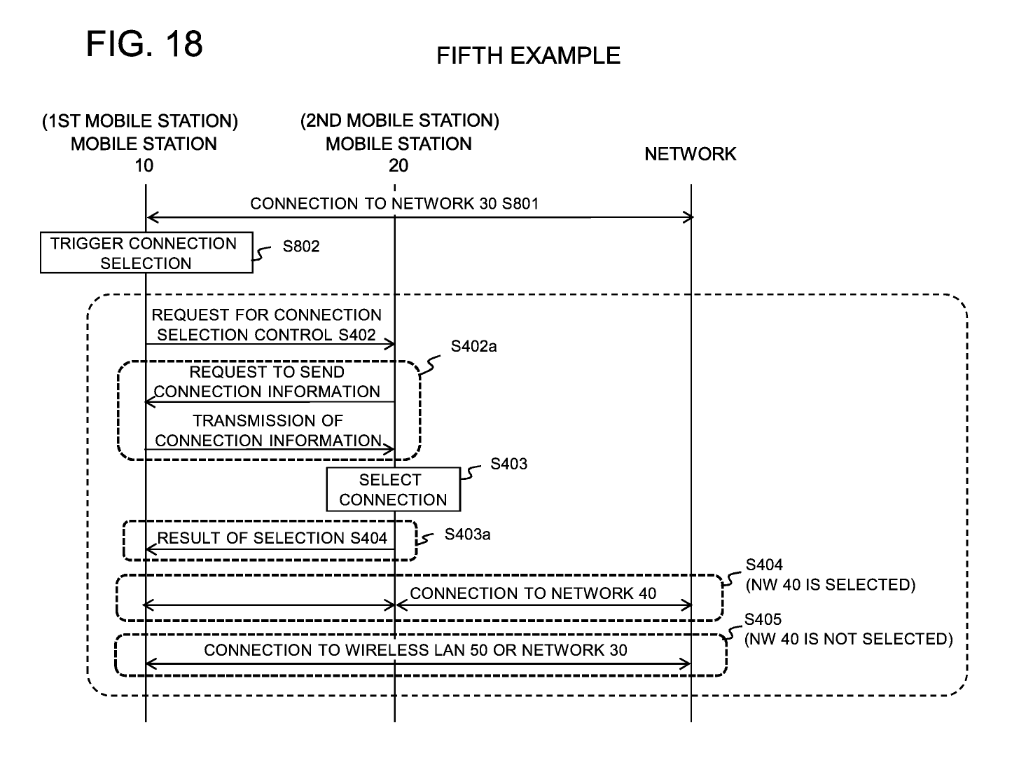

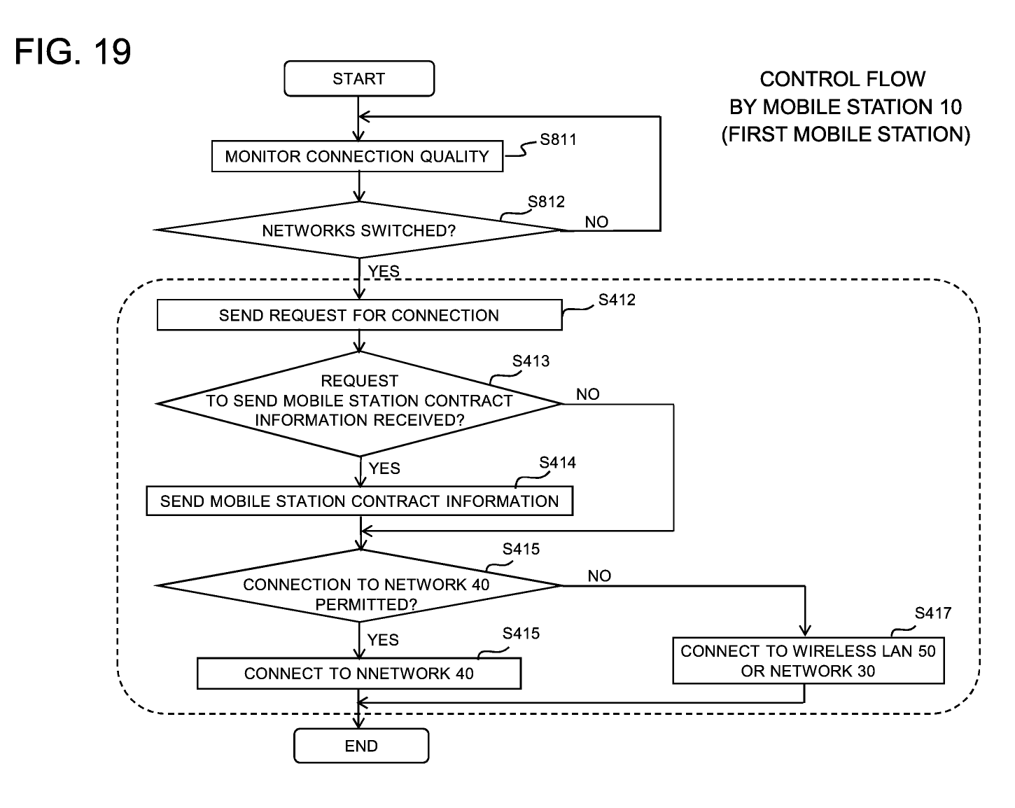

According to a fifth example of the present invention, when the mobile station 10 detects degradation in connection quality when it is connected to the mobile network 30, the mobile station 10 can switch to a connection on the mobile station 20 side. The then connection selection control is performed by, for example, the mobile station 20 as in the above-described first example. Hereinafter, system operations and operations of the mobile station 10 according to the fifth example will be described with reference to FIGS. 18 and 19.

Referring to FIG. 18, it is assumed that the mobile station 10 is connected to the mobile network 30 (Operation S801). At this time, when the mobile station 10 detects degradation in connection quality, or a disconnection, in the mobile network 30 (Operation S802), that triggers connection selection, so that the mobile station 10 sends a request for a connection to the mobile station 20 if a connection on the mobile network 40 side is better (Operation S402). Thereafter, Operations S402 to S405, with Operations S401a and S403a as options, are performed as described in the first example shown in FIG. 6. That is, a connection can be made to the mobile network 40 or 30 depending on a result of selection in Operation S403 (Operation S404 or S405). Note that connection selection control may be performed at the upper-level network as in the second example shown in FIG. 11.

Referring to FIG. 19, the connection control section 105 of the mobile station 10, when connected to the mobile network 30, monitors connection quality on the mobile network 30 side and connection quality on the mobile network 40 side (Operation S811) and, when the connection quality degrades below a predetermined threshold, or a disconnection occurs, on the mobile network 30 side, starts an operation for switching to a connection on the mobile network 40 side (Operation S812; YES). Since a procedure for connecting to the mobile network 40 is the same as the flow shown in FIG. 7 (Operations S412 to S417), a description thereof, given the same reference signs, will be omitted.

As described above, according to the fifth example of the present invention, degradation in connection quality or a disconnection triggers the switching of connections, whereby it is possible for the mobile station 10 to continue communication via a good-quality network, or to avoid a situation where a communication operation is interrupted for a long time.

### 8. Additional Statements

Part or all of the above-described exemplary embodiments also can be stated as in, but is not limited to, the following additional statements.

### (Additional Statement 1)

A communication system including a plurality of networks, comprising a first mobile station that can connect to a first network and a second mobile station that can connect to a second network, wherein the first mobile station has a function of connecting to the second network via the second mobile station, characterized in that the first mobile station sends an activation request to activate connection selection control to the second mobile station.

### (Additional Statement 2)

The communication system according to additional statement 1, characterized in that the first mobile station sends the activation request to the second mobile station when the first mobile station falls in an operational state where communication can occur.

### (Additional Statement 3)

The communication system according to additional statement 2, characterized in that the first mobile station sends the activation request to the second mobile station when a display of the first mobile station is turned on.

### (Additional Statement 4)

The communication system according to additional statement 2, characterized in that the first mobile station sends the activation request to the second mobile station when an application involving communication is started in, or such an application is operated on, the first mobile station.

### (Additional Statement 5)

The communication system according to additional statement 2, characterized in that the first mobile station sends the activation request to the second mobile station when communication quality in a network to which the first mobile station is connected degrades below a predetermined value.

### (Additional Statement 6)

The communication system according to any one of additional statements 1 to 5, characterized in that the first mobile station sends the activation request to the second mobile station only when a predetermined condition is satisfied.

### (Additional Statement 7)

The communication system according to additional statement 6, characterized in that the predetermined condition is a condition related to an allowable amount of delay of a service used by the first mobile station.

### (Additional Statement 8)

The communication system according to additional statement 7, characterized in that the predetermined condition is that the allowable amount of delay is not smaller than a predetermined value.

### (Additional Statement 9)

The communication system according to additional statement 6, characterized in that the predetermined condition is a condition related to communication quality in the first network.

### (Additional Statement 10)

The communication system according to additional statement 9, characterized in that the predetermined condition is that the communication quality is not greater than a predetermined value.

### (Additional Statement 11)

The communication system according to additional statement 6, characterized in that the predetermined condition is a condition related to a size of data transmitted/received by the first mobile station.

### (Additional Statement 12)

The communication system according to additional statement 11, characterized in that the predetermined condition is that the size of data is not smaller than a predetermined value.

### (Additional Statement 13)

The communication system according to any one of additional statements 1 to 12, characterized in that the second mobile station, when receiving the activation request, selects a network for the first mobile station to connect to.

### (Additional Statement 14)

The communication system according to additional statement 13, characterized in that the second mobile station selects a network for the first mobile station to connect to, based on first communication quality in the first network and communication quality in the second network.

### (Additional Statement 15)

The communication system according to additional statement 14, characterized in that the first communication quality is measured by the first mobile station and notified to the second mobile station.

### (Additional Statement 16)

The communication system according to additional statement 14, characterized in that the first communication quality is measured by the second mobile station.

### (Additional Statement 17)

The communication system according to any one of additional statements 13 to 16, characterized in that the second mobile station notifies information about the selected network to the first mobile station.

### (Additional Statement 18)

The communication system according to any one of additional statements 1 to 12, characterized in that the second mobile station, when receiving the activation request from the first mobile station, notifies a request for connection selection corresponding to this activation request to a upper-level network.

### (Additional Statement 19)

The communication system according to additional statement 18, characterized in that the upper-level network, when receiving the request for connection selection, selects a network for the first mobile station to connect to.

### (Additional Statement 20)

The communication system according to additional statement 19, characterized in that the upper-level network selects a network for the first mobile station to connect to, based on first communication quality in the first network and communication quality in the second network.

### (Additional Statement 21)

The communication system according to any one of additional statements 18 to 20, characterized in that the upper-level network notifies information about the selected network to the first mobile station.

### (Additional Statement 22)

The communication system according to any one of additional statements 1 to 12, characterized in that the second mobile station, when receiving the activation request from the first mobile station, sends communication quality in the second network to the first mobile station.

### (Additional Statement 23)

The communication system according to additional statement 22, characterized in that the first mobile station selects a network for its own station to connect to, based on first communication quality in the first network and communication quality in the second network.

### (Additional Statement 24)

The communication system according to any one of additional statements 1 to 23, characterized in that when the first network is selected, the second mobile station disconnects a wireless connection from the first mobile station.

### (Additional Statement 25)

A connection selection control method in a communication system including a first mobile station that can connect to a first network and a second mobile station that can connect to a second network, wherein the first mobile station has a function of connecting to the second network via the second mobile station, characterized by comprising:

by the first mobile station, sending an activation request to activate connection selection control to the second mobile station.

### (Additional Statement 26)

The connection selection control method according to additional statement 25, characterized in that the first mobile station sends the activation request to the second mobile station when the first mobile station falls in an operational state where communication can occur.

### (Additional Statement 27)

The connection selection control method according to additional statement 26, characterized in that the first mobile station sends the activation request to the second mobile station when a display of the first mobile station is turned on.

### (Additional Statement 28)

The connection selection control method according to additional statement 26, characterized in that the first mobile station sends the activation request to the second mobile station when an application involving communication is started in, or such an application is operated on, the first mobile station.

### (Additional Statement 29)

The connection selection control method according to additional statement 26, characterized in that the first mobile station sends the activation request to the second mobile station when communication quality in a network to which the first mobile station is connected degrades below a predetermined value.

### (Additional Statement 30)

The connection selection control method according to any one of additional statements 25 to 29, characterized in that the first mobile station sends the activation request to the second mobile station only when a predetermined condition is satisfied.

### (Additional Statement 31)

The connection selection control method according to additional statement 30, characterized in that the predetermined condition is a condition related to an allowable amount of delay of a service used by the first mobile station.

### (Additional Statement 32)

The connection selection control method according to additional statement 31, characterized in that the predetermined condition is that the allowable amount of delay is not smaller than a predetermined value.

### (Additional Statement 33)

The connection selection control method according to additional statement 30, characterized in that the predetermined condition is a condition related to communication quality in the first network.

### (Additional Statement 34)

The connection selection control method according to additional statement 33, characterized in that the predetermined condition is that the communication quality is not greater than a predetermined value.

### (Additional Statement 35)

The connection selection control method according to additional statement 30, characterized in that the predetermined condition is a condition related to a size of data transmitted/received by the first mobile station.

### (Additional Statement 36)

The connection selection control method according to additional statement 35, characterized in that the predetermined condition is that the size of data is not smaller than a predetermined value.

### (Additional Statement 37)

The connection selection control method according to any one of additional statements 25 to 36, characterized in that the second mobile station, when receiving the activation request, selects a network for the first mobile station to connect to.

### (Additional Statement 38)

The connection selection control method according to additional statement 37, characterized in that the second mobile station selects a network for the first mobile station to connect to, based on first communication quality in the first network and communication quality in the second network.

### (Additional Statement 39)

The connection selection control method according to additional statement 38, characterized in that the first communication quality is measured by the first mobile station and notified to the second mobile station.

### (Additional Statement 40)

The connection selection control method according to additional statement 38, characterized in that the first communication quality is measured by the second mobile station.

### (Additional Statement 41)

The connection selection control method according to any one of additional statements 37 to 40, characterized in that the second mobile station notifies information about the selected network to the first mobile station.

### (Additional Statement 42)

The connection selection control method according to any one of additional statements 25 to 36, characterized in that the second mobile station, when receiving the activation request from the first mobile station, notifies a request for connection selection corresponding to this activation request to a upper-level network.

### (Additional Statement 43)

The connection selection control method according to additional statement 42, characterized in that the upper-level network, when receiving the request for connection selection, selects a network for the first mobile station to connect to.

### (Additional Statement 44)

The connection selection control method according to additional statement 43, characterized in that the upper-level network selects a network for the first mobile station to connect to, based on first communication quality in the first network and communication quality in the second network.

### (Additional Statement 45)

The connection selection control method according to any one of additional statements 42 to 44, characterized in that the upper-level network notifies information about the selected network to the first mobile station.

### (Additional Statement 46)

The connection selection control method according to any one of additional statements 25 to 36, characterized in that the second mobile station, when receiving the activation request from the first mobile station, sends communication quality in the second network to the first mobile station.

### (Additional Statement 47)

The connection selection control method according to additional statement 46, characterized in that the first mobile station selects a network for its own station to connect to, based on first communication quality in the first network and communication quality in the second network.

### (Additional Statement 48)

The connection selection control method according to any one of additional statements 25 to 47, characterized in that when the first network is selected, the second mobile station disconnects a wireless connection from the first mobile station.

### (Additional Statement 49)

A communication device in a communication system including first and second networks and a mobile station that can connect to the first network, wherein the communication device can connect to the second network and has a function of allowing the mobile station to connect to the second network, characterized by comprising:

connection selection control means for selecting a network for the mobile station to connect to, in response to an request to activate connection selection control received from the mobile station.

### (Additional Statement 50)

The communication device according to additional statement 49, characterized in that the connection selection control means selects a network for the mobile station to connect to, based on first communication quality in the first network and communication quality in the second network.

### (Additional Statement 51)

The communication device according to additional statement 50, characterized in that the connection selection control means receives from the mobile station the first communication quality measured by the mobile station.

### (Additional Statement 52)

The communication device according to additional statement 50, characterized in that the connection selection control means measures the first communication quality.

### (Additional Statement 53)

The communication device according to any one of additional statements 49 to 52, characterized in that the connection selection control means notifies information about the selected network to the mobile station.

### (Additional Statement 54)

The communication device according to any one of additional statements 49 to 53, characterized in that when the first network is selected, the the connection selection control means disconnects a wireless connection from the mobile station.

### (Additional Statement 55)

A communication device in a communication system including a first mobile station that can connect to a first network and a second mobile station that can connect to a second network, wherein the first mobile station has a function of connecting to the second network via the second mobile station, the communication device being provided in a upper-level network than a base station in the second network, characterized by comprising:

connection selection control means for selecting a network for the first mobile station to connect to, in response to an activation request to activate connection selection control received from the first mobile station.

### (Additional Statement 56)

The communication device according to additional statement 55, characterized in that the connection selection control means selects a network for the first mobile station to connect to, based on first communication quality in the first network and communication quality in the second network.

### (Additional Statement 57)

The communication device according to additional statement 55 or 56, characterized in that the connection selection control means notifies information about the selected network to the first mobile station.

### (Additional Statement 58)

A communication device in a communication system including first and second networks and a mobile station that can connect to the second network, wherein the communication device can connect to the first network and is capable of wirelessly communicating with the mobile station, characterized by comprising:

connection control means that sends an activation request to activate connection selection control to the mobile station.

### (Additional Statement 59)

The communication device according to additional statement 58, characterized in that the connection control means sends the activation request to the mobile station when an operational state arises where communication can occur.

### (Additional Statement 60)

The communication device according to additional statement 59, characterized in that the connection control means sends the activation request to the mobile station when a display of the communication device is turned on.

### (Additional Statement 61)

The communication device according to additional statement 59, characterized in that the connection control means sends the activation request to the mobile station when an application involving communication is started in, or such an application is operated on, the communication device.

### (Additional Statement 62)

The communication device according to additional statement 59, characterized in that the connection control means sends the activation request to the mobile station when communication quality in a network to which the communication device is connected degrades below a predetermined value.

### (Additional Statement 63)

The communication device according to any one of additional statements 58 to 62, characterized in that the connection control means sends the activation request to the mobile station only when a predetermined condition is satisfied.

### (Additional Statement 64)

The communication device according to additional statement 63, characterized in that the predetermined condition is a condition related to an allowable amount of delay of a service used by the communication device.

### (Additional Statement 65)

The communication device according to additional statement 64, characterized in that the predetermined condition is that the allowable amount of delay is not smaller than a predetermined value.

### (Additional Statement 66)

The communication device according to additional statement 63, characterized in that the predetermined condition is a condition related to communication quality in the first network.

### (Additional Statement 67)

The communication device according to additional statement 66, characterized in that the predetermined condition is that the communication quality is not greater than a predetermined value.

### (Additional Statement 68)

The communication device according to additional statement 63, characterized in that the predetermined condition is a condition related to a size of data transmitted/received by the communication device.

### (Additional Statement 69)

The communication device according to additional statement 68, characterized in that the predetermined condition is that the size of data is not smaller than a predetermined value.

### (Additional Statement 70)

The communication device according to any one of additional statements 58 to 70, characterized in that the connection control means, after sending the activation request to the mobile station, receives information about the selected network from the mobile station or a upper-level network thereof.

### (Additional Statement 71)

A communication control method for a communication device in a communication system including first and second networks and a mobile station that can connect to the first network, wherein the communication device can connect to the second network and has a function of allowing the mobile station to connect to the second network, characterized by comprising:

selecting a network for the mobile station to connect to, in response to an activation request to activate connection selection control received from the mobile station.

### (Additional Statement 72)

A communication control method for a communication device in a communication system including a first mobile station that can connect to a first network and a second mobile station that can connect to a second network, wherein the first mobile station has a function of connecting to the second network via the second mobile station, the communication device being provided in a upper-level network than a base station in the second network, characterized by comprising:

selecting a network for the first mobile station to connect to, in response to an activation request to activate connection selection control received from the first mobile station.

### (Additional Statement 73)

A communication control method for a communication device in a communication system including first and second networks and a mobile station that can connect to the second network, wherein the communication device can connect to the first network and is capable of wirelessly communicating with the mobile station, characterized by comprising:

sending an activation request to activate connection selection control to the mobile station.

### INDUSTRIAL APPLICABILITY

The present invention is applicable to mobile communication systems using mobile routers, smartphones having tethering function, or the like.

### REFERENCE SIGNS LIST

10 Mobile station (first mobile station)
20 Mobile station (second mobile station)
30 Mobile network (first network)
40 Mobile network (second network)
50 Wireless LAN
60 External network
70 Upper-level network device

1. A communication system including a plurality of networks, comprising: a first mobile station connectable to a first network; and a second mobile station connectable to a second network, wherein the first mobile station has a function of connecting to the second network via the second mobile station,
wherein the first mobile station sends an activation request to activate connection selection control to the second mobile station.

2. The communication system according to claim 1, wherein the first mobile station sends the activation request to the second mobile station when the first mobile station falls in an operational state where communication can occur.

3. The communication system according to claim 2, wherein the first mobile station sends the activation request to the second mobile station when a display of the first mobile station is turned on.

4. The communication system according to claim 2, wherein the first mobile station sends the activation request to the second mobile station when an application involving communication is started in the first mobile station or when the application is operated on the first mobile station.

5. The communication system according to claim 2, wherein the first mobile station sends the activation request to the second mobile station when communication quality in a network to which the first mobile station is connected degrades below a predetermined value.

6. The communication system according to claim 1, wherein the first mobile station sends the activation request to the second mobile station only when a predetermined condition is satisfied.

7. The communication system according to claim 6, wherein the predetermined condition is a condition related to an allowable amount of delay of a service used by the first mobile station.

8. The communication system according to claim 6, wherein the predetermined condition is a condition related to communication quality in the first network.

9. The communication system according to claim 6, wherein the predetermined condition is a condition related to a size of data transmitted/received by the first mobile station.

10. The communication system according to claim 1, wherein the second mobile station, when receiving the activation request, selects a network for the first mobile station to connect to.

11. The communication system according to claim 10, wherein the second mobile station selects a network for the first mobile station to connect to, based on communication quality in the first network and communication quality in the second network.

12. The communication system according to claim 1, wherein the second mobile station, when receiving the activation request from the first mobile station, notifies an upper-level network of a connection selection request corresponding to the activation request.

13. The communication system according to claim 12, wherein the upper-level network, when receiving the connection selection request, selects a network for the first mobile station to connect to.

14. The communication system according to claim 13, wherein the upper-level network selects a network for the first mobile station to connect to, based on communication quality in the first network and communication quality in the second network.

15. The communication system according to claim 1, wherein the second mobile station, when receiving the activation request from the first mobile station, sends communication quality in the second network to the first mobile station.

16. The communication system according to claim 15, wherein the first mobile station selects a network for its own station to connect to, based on communication quality in the first network and communication quality in the second network.

17. The communication system according to claim 1, wherein when the first network is selected, the second mobile station disconnects a wireless connection from the first mobile station.

18. A connection selection control method in a communication system including a first mobile station connectable to a first network and a second mobile station connectable to a second network, wherein the first mobile station has a function of connecting to the second network via the second mobile station, wherein
the first mobile station sends a activation request for connection selection control to the second mobile station.

19. The connection selection control method according to claim 18, wherein the first mobile station sends the activation request to the second mobile station when the first mobile station falls in an operational state where communication can occur.

20. The connection selection control method according to claim 19, wherein the first mobile station sends the activation request to the second mobile station when a display of the first mobile station is turned on.

21. The connection selection control method according to claim 19, wherein the first mobile station sends the activation request to the second mobile station when an application involving communication is started in the first mobile station or when the application is operated on the first mobile station.

22. The connection selection control method according to claim 19, wherein the first mobile station sends the activation request to the second mobile station when communication quality in a network to which the first mobile station is connected degrades below a predetermined value.

23. The connection selection control method according to claim 18, wherein the first mobile station sends the activation request to the second mobile station only when a predetermined condition is satisfied.

24. The connection selection control method according to claim 23, wherein the predetermined condition is a condition related to an allowable amount of delay of a service used by the first mobile station.

25. The connection selection control method according to claim 23, wherein the predetermined condition is a condition related to communication quality in the first network.

26. The connection selection control method according to claim 23, wherein the predetermined condition is a condition related to a size of data transmitted/received by the first mobile station.

27. The connection selection control method according to claim 18, wherein the second mobile station, when receiving the activation request, selects a network for the first mobile station to connect to.

28. The connection selection control method according to claim 27, wherein the second mobile station selects a network for the first mobile station to connect to, based on first communication quality in the first network and communication quality in the second network.

29. The connection selection control method according to claim 18, wherein the second mobile station, when receiving the activation request from the first mobile station, notifies an upper-level network of a request for connection selection corresponding to this activation request.

30. The connection selection control method according to claim 29, wherein the upper-level network, when receiving the request for connection selection, selects a network for the first mobile station to connect to.

31. The connection selection control method according to claim 30, wherein the upper-level network selects a network for the first mobile station to connect to, based on first communication quality in the first network and communication quality in the second network.

32. The connection selection control method according to claim 18, wherein the second mobile station, when receiving the activation request from the first mobile station, sends communication quality in the second network to the first mobile station.

33. The connection selection control method according to claim 32, wherein the first mobile station selects a network for its own station to connect to, based on first communication quality in the first network and communication quality in the second network.

34. The connection selection control method according to claim 18, wherein when the first network is selected, the second mobile station disconnects a wireless connection from the first mobile station.

35. A communication device in a communication system including first and second networks and a mobile station connectable to the first network, wherein the communication device can connect to the second network and has a function of allowing the mobile station to connect to the second network, comprising:
a connection selection controller for selecting a network for the mobile station to connect to, in response to a activation request for connection selection control received from the mobile station.

36. A communication device in a communication system including a first mobile station connectable to a first network and a second mobile station connectable to a second network, wherein the first mobile station has a function of connecting to the second network via the second mobile station, the communication device being provided in an upper-level network than a base station in the second network, comprising:
a connection selection controller for selecting a network for the first mobile station to connect to, in response to a activation request for connection selection control received from the first mobile station.

37. A communication device in a communication system including first and second networks and a mobile station connectable to the second network, wherein the communication device can connect to the first network and is capable of wirelessly communicating with the mobile station, comprising:
a connection controller that sends a activation request for connection selection control to the mobile station.

38. A communication control method for a communication device in a communication system including first and second networks and a mobile station connectable to the first network, wherein the communication device can connect to the second network and has a function of allowing the mobile station to connect to the second network, comprising:
selecting a network for the mobile station to connect to, in response to a activation request for connection selection control received from the mobile station.

39. A communication control method for a communication device in a communication system including a first mobile station connectable to a first network and a second mobile station connectable to a second network, wherein the first mobile station has a function of connecting to the second network via the second mobile station, the communication device being provided in an upper-level network than a base station in the second network, comprising:
selecting a network for the first mobile station to connect to, in response to a activation request for connection selection control received from the first mobile station.

40. A communication control method for a communication device in a communication system including first and second networks and a mobile station connectable to the second network, wherein the communication device can connect to the first network and is capable of wirelessly communicating with the mobile station, comprising:
sending a activation request for connection selection control to the mobile station.
